(19) United States
(12) Patent Application Publication
(10) Pub. No.: US 2009/0132355 A1
(43) Pub. Date: May 21, 2009

(54) SYSTEM AND METHOD FOR AUTOMATICALLY SELECTING ADVERTISING FOR VIDEO DATA

(75) Inventors: Lee Begeja, Gillette, NJ (US); David C. Gibbon, Lincroft, NJ (US); Paul Van Vleck, Austin, TX (US)

Correspondence Address: AT&T Legal Department - Roebuck;Attn: Patent Docketing, One AT&T Way,, Room 2A-207, Bedminster, NJ, 07921, US

(73) Assignee: ATT Knowledge Ventures L.P., Reno, NV (US)

(21) Appl. No.: 11/942,129

(22) Filed: Nov. 19, 2007

(51) Int. Cl. G06Q 30/00

(52) U.S. Cl. 705/14

(57) ABSTRACT

A method is disclosed for selecting advertising data, comprising detecting a plurality of different scenes in a video data stream; correlating each of the scenes with a plurality of advertising data classes; and selecting advertising data for one of the scenes based on the correlation. A system is disclosed for performing the method. A data structure embedded in a computer readable medium is disclosed for containing data for performing the method.

### FIELD OF THE DISCLOSURE

The present disclosure relates to the field of selecting advertisements for video data.

### BACK GROUND OF THE DISCLOSURE

Targeted advertisements have historically been mailed to large targeted geographic areas such as a particular city, so that regional advertisers reach only persons who are deemed by the advertiser as most likely to be responsive to their advertisements. Advertisements are a component in digital video services, including live or pre-recorded broadcast television TV, special or pay-per-view programming, video on demand (VOD), and other content choices available to subscribers. Television advertisers now target advertisements based on regions in which the television signal is delivered. For example, viewers in a New York state region will receive different advertising data than viewers in a Texas state region.

### BRIEF DESCRIPTION OF THE DRAWINGS

FIG. 1 depicts an illustrative embodiment of a system for delivering advertising data;

FIG. 2 depicts another more detailed illustrative embodiment of a system for delivering advertising data;

FIG. 3 depicts a flow chart of functions performed in an illustrative method for delivering advertising data;

FIG. 4 depicts a data structure embedded in a computer readable medium that is used by a processor and method for delivering advertising data in another illustrative embodiment;

FIG. 5 depicts a data structure embedded in a computer readable medium that is used by a processor and method for delivering advertising data in another illustrative embodiment; and

FIG. 6 depicts an illustrative embodiment of a machine for performing functions disclosed in another illustrative embodiment.

### DETAILED DESCRIPTION

In a particular embodiment, a method is disclosed for selecting advertising data, comprising detecting a plurality of different scenes in a video data stream; correlating each of the scenes with a plurality of advertising data classes; and selecting advertising data for one of the scenes based on the correlation. In another particular embodiment of the method, the method further includes classifying the scenes into scene classes, wherein correlating further comprises correlating the scene classes with the advertising data classes. In another particular embodiment of the method, the method further including auctioning an advertising spot to obtain an auction price for one of the scenes based on the correlation, plus demographics and end user devices for current end users to which the advertising will be made available. In another particular embodiment of the method, one of the scenes further comprises a plurality of scenes bridged together into a bridged scene, wherein the bridged scenes share a common topic based on data in the bridged scenes selected from the group consisting of image, audio and text data.

In another particular embodiment of the method, the demographics further comprises an average demographic profile for current end user receiving the video data served by an internet protocol television (IPTV) server. In another particular embodiment of the method, the method further includes seeding the scene classes with initial key words using meta data for the video data; seeding the advertising data classes with initial key words using Meta data for the advertising data; and determining a classification for the scene and advertising data using machine learning. In another particular embodiment of the method, correlating further comprises correlating feature vectors for the scenes with feature vectors for the advertising data. In another particular embodiment of the method, selecting further comprises selecting an advertising class based on a probability of a video scene class matching an advertising data class. In another particular embodiment of the method, selecting further comprises selecting highest probable revenue advertising data classification category based on an auction value for advertising data class for the advertising spot and an end user selection probability for each of the advertising data classes. In another particular embodiment of the method, the method further includes presenting as available the selected advertising data in the selected advertising class to the at least one end user; evaluating an end user response to the advertising data; and adjusting the end user selection probability for the advertising data classification category for the end user based on the end user response. In another particular embodiment of the method, the feature vectors further comprise Meta data describing the data, image data, audio data, and text data.

In another particular embodiment of the a system for selecting advertising data is disclosed, the system comprising a processor in data communication with a computer readable medium; a computer program embedded in the computer readable medium, the computer program comprising instructions to detect a plurality of different scenes in a video data stream, instructions to correlate each of the scenes with a plurality of advertising data classes and instructions to select advertising data for one of the scenes based on the correlation. In another particular embodiment of the system, the computer program further includes instructions to classify the scenes into scene classes, wherein correlating further comprises correlating the scene classes with the advertising data classes. In another particular embodiment of the system, the computer program further comprises instructions to auction an advertising spot to obtain an auction price for one of the scenes based on the correlation, plus demographics and end user devices for current end users to which the advertising will be made available. In another particular embodiment of the system, one of the scenes further comprises a plurality of scenes bridged together into a bridged scene, wherein the bridged scenes share a common topic based on data in the bridged scenes selected from the group consisting of image, audio and text data. In another particular embodiment of the system, the demographics further comprise an average demographic profile for current end users receiving the video data served by an internet protocol television (IPTV) server.

In another particular embodiment of the system, the instructions to classify further comprise instructions to seed the scene classes with initial key words using Meta data for the video data, instructions to seed the advertising data classes with initial key words using meta data for the advertising data and instructions to determine a classification for the scene and advertising data using machine learning. In another particular embodiment of the system, correlating further comprises correlating feature vectors for the scenes with feature vectors for the advertising data. In another particular embodiment of the system, the instructions to select further comprise instructions to select an advertising class based on a probability of a video scene class matching an advertising data class. In another particular embodiment of the system, the instructions to select further comprise selecting highest probable revenue advertising data classification category based on an auction value for advertising data class for the advertising spot and an end user selection probability for each of the advertising data classes.

In another embodiment a computer readable medium is disclosed containing instructions that when executed by a computer perform a method for selecting advertising data the computer program comprising instructions to detect a plurality of different scenes in a video data stream, instructions to correlate each of the scenes with a plurality of advertising data classes and instructions to select advertising data for one of the scenes based on the correlation. In another embodiment a data structure embedded in a computer readable medium is disclosed, the data structure comprising a first field for containing data indicative of a video segment classification; a second field for containing data indicative of an advertising data classification; and a third field for containing data indicative of a probability of the video segment classification matching the advertising data classification. In another embodiment a system is disclosed for receiving advertising data, the system comprising a processor in data communication with a computer readable medium; a computer program embedded in the computer readable medium, the computer program comprising instructions to receive advertising data available indicators for a plurality of different scenes in a video data stream.

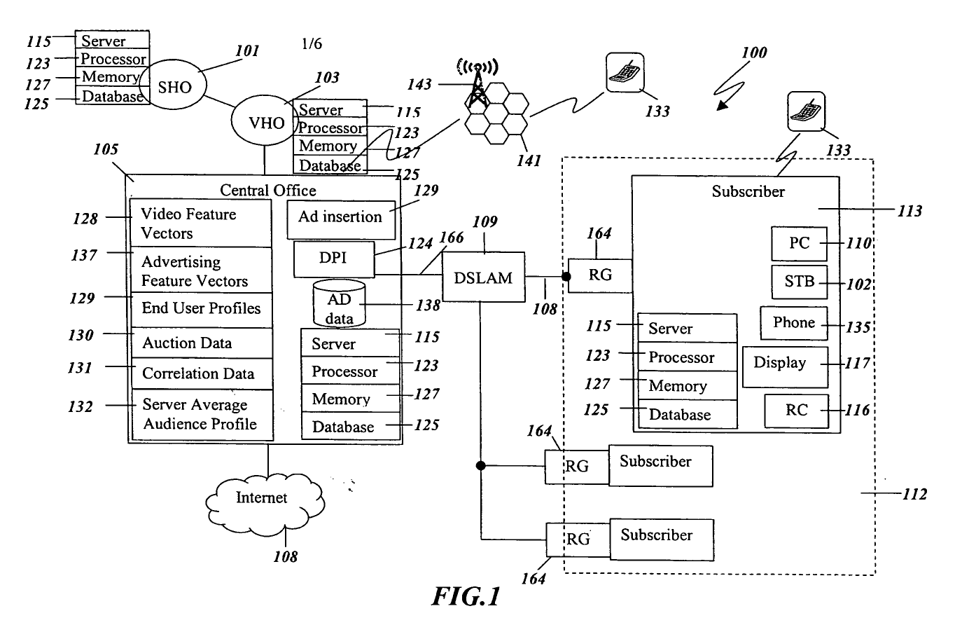

Turning now to FIG. 1, FIG. 1 depicts an illustrative embodiment of a system for automatically selecting advertising for a subscriber based on content of video segments. The video segments are provided via a three screen internet protocol television (IPTV) system (providing IPTV, wireless (WiFi and Cellular) telephone, voice over internet protocol (VoIP) and Internet). The three screen IPTV system provides IPTV video, high speed internet video and other data from high speed internet and VoIP data and video. The video segments can be video data including but not limited to television programming, movies, video on demand in which Meta data describing the video data may be supplied or video data without associated Meta data such as subscriber created video such as video provided on popular Internet sites such as MySpace™ and YouTube™.

In an illustrative embodiment, the IPTV system builds subscriber profiles for IPTV subscribers by aggregating and correlating subscriber related statistics and subscriber activity data along with other subscriber data and demographic information such as gender, age, income, languages spoken, areas of interest, etc. Some of the subscriber profile data can be volunteered by an IPTV subscriber during an IPTV registration process. In another particular embodiment the subscriber profile data further contains data for which a subscriber has opted in for monitoring and use by an IPTV three screen system for the purposes of automatically receiving targeted advertising data. Subscriber preferences for particular advertising classes of current viewers can be estimated from data included in the subscriber profile, including but not limited to device type, subscriber type, and device state based on the subscriber activity data.

Based on subscribers' interests, background, and subscriber profiling results, demographics and subscriber activity data one of the following targeted advertising data delivery methods and systems described herein or an equivalent thereof can be utilized to estimate an auction price for selecting targeted advertising. Targeted advertising is automatically selected and made available to personalized advertising data and television commercial delivery to IPTV television displays, portable subscriber data and messaging devices such as mobile or cell phones and video, website banners and pop up displays on a PC or mobile Laptop computer.

As shown in FIG. 1, the IPTV system 100 delivers video content and targeted advertising to subscriber house holds 113 and associated end user devices (referred to herein as subscriber devices) which may be inside or outside of the household. Television advertising data is inserted or marked as available by the advertising server 138. In the IPTV system, IPTV video data are first broadcast in an internet protocol (IP) from a server at a super hub office (SHO) 101 to a regional or local IPTV video hub office (VHO) server 103, to a central office (CO) server 105. The IPTV system 100 includes a hierarchically arranged network of servers wherein the SHO transmits video and advertising data to a video hub office (VHO) 103 and the VHO transmits to an IPTV server location close to a subscriber, such as a CO server 105. In another particular embodiment, each of the SHO, VHO, and CO is interconnected with an IPTV transport 166. The IPTV transport 166 may consist of high speed fiber optic cables interconnected with routers for transmission of internet protocol data. The IPTV servers also provide data communication for data and video associated with Internet and VoIP services to subscribers.

Actively viewed IPTV channels are sent in an Internet protocol (IP) data multicast group to access nodes such as digital subscriber line access multiplexers (DSLAMS) 109. A multicast for a particular IPTV channel is joined over a DSL line 108 by the set-top boxes (STBs) at IPTV subscriber homes from the DSLAM. Each SHO, VHO, CO and STB includes a server 115, processor 123, a memory 127, and a database 125. The processor 123 further includes a network interface. The network interface functions to send and receive data over the IPTV transport 166 and DSL line 108. The CO server delivers IPTV, Internet and VoIP video content to the subscriber via the DSLAM. The television internet and VoIP content can be delivered via multicast and unicast television advertising data via unicast or multicast depending on a single subscriber or a targeted television advertising group of end user client subscriber devices to which the advertising data is directed.

In another particular embodiment, subscriber devices, including but not limited to, wire line phones 135, mobile and cellular phones 133, personal computers (PC) 110 and STB 102 communicate with the communication system, i.e., IPTV system through residential gateway (RG) 164 and high speed communication lines 108 and 166. In another particular embodiment, DPI device 124 inspects VoIP, Internet and IPTV video data, data, commands and Meta data transmitted between the subscriber devices and the IPTV system servers. In another illustrative embodiment subscriber activity data are monitored and collected whether or not the subscriber's devices are in the household 113 or traveling as mobile devices outside of the household. When outside of the household, subscriber mobile device activity data and transactions data are monitored by communication network (e.g. IPTV) servers which associate the subscriber activity factors data with particular subscribers. The IPTV three screen network communicates with cellular phone and mobile wireless phones through wireless WiFi and cellular network 141. In another particular embodiment, subscriber activity data such as communication and purchase transactions are inspected by DPI devices located in a communication system, e.g., IPTV system servers. These communication system servers route the subscriber activity data to an IPTV server such as the CO in which the subscriber activity data for a subscriber are stored for processing. While an IPTV system has been used as an example in the illustrative embodiment, the disclosure is not meant to be limited to IPTV as other communication systems such as cable television or other digital and analog data delivery systems can be used in other embodiments. For example, hybrid systems like the combination of satellite delivery of video data combined with DSL for video on demand and interactive applications can be used in another embodiment.

In another particular embodiment, the end user subscriber devices include but are not limited to a client user computer, a personal computer (PC), a tablet PC, a set-top box (STB), a Personal Digital Assistant (PDA), a cellular telephone, a mobile device, a palm computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. In another particular embodiment, a deep packet inspection (DPI) device 124 inspects multicast and unicast data, including but not limited to VoIP video and data, Internet video and data and IPTV video and data, commands and Meta data between the subscriber end user devices and the IPTV system servers and the Internet. In another illustrative subscriber activity data are monitored and collected whether or not the subscriber devices are in the household 113 or the devices are mobile outside of the household. When outside of the household, subscriber mobile device data are monitored by communication system (e.g. IPTV) servers which associate the subscriber activity data with each particular subscriber's device. In another particular embodiment, subscriber activity data such as IPTV and Internet video selections, and communication and purchase transactions are inspected by DPI devices located in a communication system, e.g., IPTV system servers. These communication system servers route the subscriber activity data to a CO in which the subscriber activity data for a subscriber are stored for processing.

As shown in FIG. 1 advertising sub groups 112 (comprising a group of subscriber house holds 113) receive multicast advertising data in video data stream from CO server 115 and DSLAM 109 at STB 102. Individual households 113 receive advertising data at set top box 102 or one of the other subscriber devices. More than one STB 102 can be located in an individual household 113 and each individual STB can receive a separate multicast or unicast advertising stream on IPTV transport 166. In another particular illustrative embodiment separate and unique advertising data are sent to each set top box (STB) 102 tailored to target the particular subscriber watching television at that particular STB. Each STB 102 has an associated remote control (RC) 116 and video display 117. The subscriber via the RC selects channels for a video data viewing selection (video programs, games, movies, video on demand) and places orders for products and services over the IPTV system 100.

FIG. 1 depicts an illustrative communication system, including but not limited to a television advertising insertion system wherein television advertising data can be inserted at an IPTV server (SHO, VHO, CO) or at the end user client subscriber device, for example, an STB, mobile phone, web browser or personal computer. Advertising data can be inserted into or made available in an IPTV video stream via advertising insertion device 129 located at the IPTV CO server 105 or at one of the end user devices such as the STB 102. The IPTV servers include an advertising server 129 and an advertising database 138. The advertising data is selected by advertising selection element 129 from the advertising database 138 based on a subscriber profile and delivered by the VHO advertising server 138 to the IPTV VHO server 115. An SHO 101 distributes data to a regional VHO 103 which distributes data to local COs 105 which distribute data to a digital subscriber access line access multiplexer (DSLAM) access node to subscriber devices such as STB 102 PC 110, wire line phone 135, mobile phone 133 etc. Advertising data is also selected based on the holistic subscriber profile and sent to a mobile phone or computer associated with the subscriber. The subscriber profile is built based on a subscriber's IPTV, Internet and VoIP activity. As shown in FIG. 1, the CO creates and stores the video classes such as feature vectors 128, advertising data classes such as feature vectors 137, end user profile data 129, auction data 130, correlation data 131 and server average audience profile data 132.

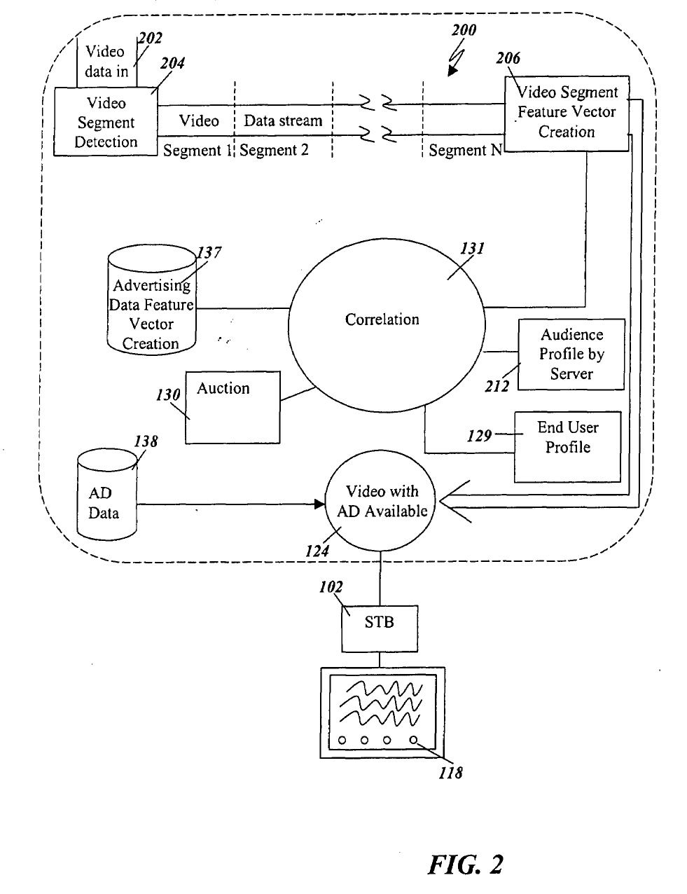

Turning now to FIG. 2, in a particular illustrative embodiment, the CO 105 contains a video segment detection device 202 which recognizes scene changes within the video data and breaks the video data into video segments 1 through N. Video segments 1 through N are fed to the video segment feature vector creation device 206 where a feature vector for each video segment is created. In creating feature vectors or classes for the video segments, the video segment feature vector creation device operates on Meta data describing the video data, image data from the video segment, video segment audio data for the video segment, and text data in the video segment and creates a feature vector for each video segment. The feature vectors device uses user linguistic understanding, pattern recognition and machine learning to develop the feature vectors. The video segment detection device and feature vector creation device are implemented by processor 123. In another embodiment, the video segment feature vector creation device is a classification device creating a classification categories (also referred to herein as “classes”) for each of the video segments based on Meta data describing the video data, image data from a video segment, video segment audio data for the video segment and, text data in the video segment. In another embodiment, the video segment feature vector creation device is a classification device creating a classification categories (also referred to herein as “classes”) for each of the video segments based on advertising data placed as seed data for the development of feature vectors or classes for the video segments. The video segment feature vector data or class data is then passed to the correlation device 131. The correlation device is implemented by processor 123.

The advertising data for a number of advertisements selected from the advertising database 138 is passed through the advertising data feature vector creation device 137. The advertising data feature vector creation device creates a feature vector or class for each advertisement. The advertising data feature vector creation device 137 takes Meta data describing the advertisement, image data from the advertisement, audio data from the advertisement, and text data from the advertisement to create the advertisement feature vector or advertising data classification category. The advertising data feature vectors are passed to the correlation device 131. The correlation device 131 compares feature vectors or classification categories for the video segments to feature vectors or classes for the advertising data. Advertisements are selected having the highest probability of matching any feature vector for one of the plurality of video segments advertisements based on audience profiles average for an IPTV server 212 or an individual end user profile 129. In another embodiment, several related video segments are bridged together when they share a common topic, based on common language, images or text in the video segments, to form a bridged segment or scene. The term scene is used herein synonymously with the word segment.

In another particular illustrative embodiment, the correlation device is implemented by support vector machines which process feature vectors created by machine learning. The machine learning can be unsupervised or supervised. In another embodiment, the initial classes for the advertisements are seeded with Meta data describing the advertisements. In another embodiment, the advertising classes or feature vectors, developed through supervised or unsupervised learning are correlated with the video segment to estimate a probability for each video segment matching one or more advertisements in the advertising classes. Other classification systems and correlation techniques such as neural networks can be used in other embodiments.

Based on the results of correlation techniques applied, advertisements that have a high probability of matching a particular video segment are selected and placed for auction at block 130. The auction prices for advertising during a segment (also referred to herein as an advertising spot) are based on the advertising category classification, video category classification and the current audience of end user(s) to which the current advertising data would be presented. The subscriber activity data in the subscriber profile is used to assess a selection probability, that is, a particular end user's or group of end users probability of selecting a particular advertisement in a particular class or category classification. This selection probability for the end user to select a particular advertising classification is multiplied by the probability of the advertising classification category matching the video segment and the auction price to yield first probable revenue for presenting the advertisement as available to an end user. If an end user profile indicates that the end user is biased against the selected advertising class, by having a selection probability below a programmable predetermined value, for example 50%, another advertisement is selected in another class and the auction revenue multiplied by his selection probability for that advertisement in the class to calculate second probable revenue. In another embodiment, at least two advertising classes are selected and probable revenues calculated for each selected advertising class. The highest probable revenue for the end user is used to select the advertising data which is present our made available for selection to the end user. The advertising data may be presented to the end user or just made available by presenting an icon 118 indicating that a particular advertisement is presently available at the end device.

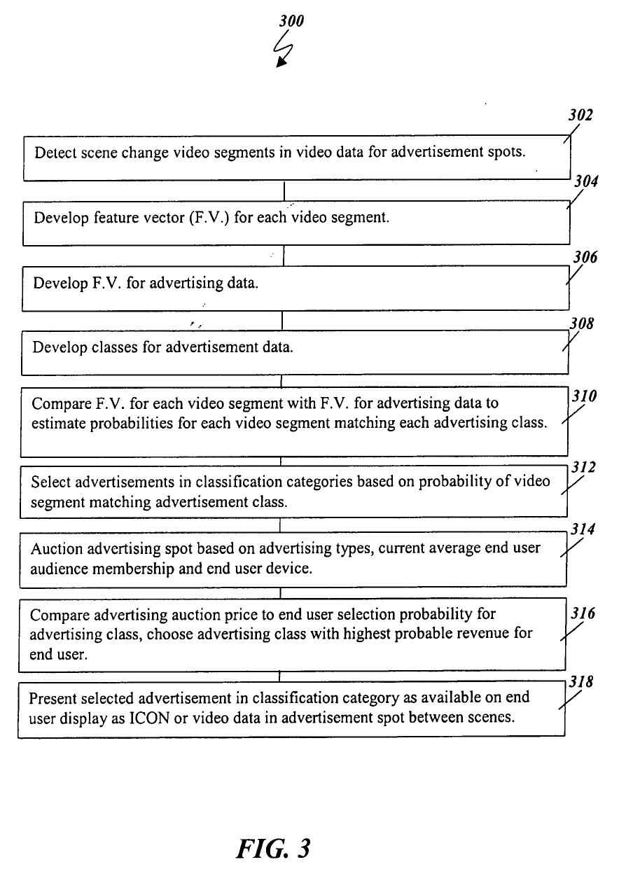

Turning now to FIG. 3, in another illustrative embodiment, a flowchart 300 of functions as shown in FIG. 3 is performed. No order of execution is meant to be implied by flow chart 300. Any of the functions in flow chart 300 may be executed or partially executed in any order or may be left out completely in other illustrative embodiments. In an illustrative embodiment of a method, in block 302 an illustrative embodiment detects scene changes or segments in the video data for locating potential advertising spots associated with different segments in the video data. Each scene or segment in the video has the potential for a different advertisement in a different advertising classification category. At block 304 an illustrative embodiment develops feature vectors for each of the detected video segments. At block 306 an illustrative embodiment develops feature vectors for the advertising data that might be proposed for availability in the advertising spots associated with the video segments. In block 308 an illustrative embodiment develops classes or feature victors for the advertising data which in an illustrative embodiment, the classes or feature vectors are processed by a support vector machine (SVM). The SVM compares the feature vectors for the advertising data against the video data segments to determine a probability for each video segment matching each of the advertisements associated with the feature vectors. In another embodiment, the SVM compares the feature vectors for the advertising data against feature vectors for the video data segments to determine a probability for each video segment matching each of the advertisements associated with the feature vectors. Other classification techniques and correlation functions such as neural networks may be utilized to match advertising classes with video segment classifications and end users in another embodiment.

At block 310 an illustrative embodiment further compares feature vectors for each video segment with feature vectors for advertising data to estimate probabilities for each video segment matching each advertising classification category or feature vector. At block 312 an illustrative embodiment selects advertisements in the classification categories based on the probability of video segment matching advertisement classification category. At block 314 an illustrative embodiment further auctions advertising spots defined by a particular video segment classification category, based on advertising classification categories and the current average audience membership available for viewing a particular advertisement at a particular IPTV server or at an end user device.

At block 316 an illustrative embodiment compares probable auction revenue to an end user preference probability for proposed advertising class category. An illustrative embodiment chooses a particular advertisement in an advertising class with the highest probable revenue for a particular end user. Another illustrative embodiment chooses a particular advertising class or group of end users with highest probable revenue for a particular group of end users. Thus, if a particular end user has a choice between a clothing advertisement and a car advertisement, the end user selection probability for selecting one of the two advertisements is multiplied by the auction price for each of the advertisements. Thus, if the clothing advertisement auction price is two dollars and the car advertisement was auction price is one dollar, without further consideration, the clothing advertisement would have been presented as available to an end user because the clothing has the highest auction price, two dollars versus one dollar. However, if the end user's profile indicates that the selection probability for the end user responding to a clothing advertisement is 20% and the selection probability of the end user responding to a car advertisement is 80% then the probable revenue for the clothing advertisement is $0.40 ($2.00×0.20) where the probable revenue for the car advertisement would be $0.80 ($1.00×0.8). Thus for this particular end user the probable revenue is higher for the lower auction price car advertisement based on the end user selection probability and the car advertisement will be presented to this particular end user. At block 318 an illustrative embodiment presents the selected advertisement in the classification category as available on an end-user device display. This can be done by present in an icon are the actual video data in an advertisement spot between scenes detected in box 302. The auction price and selection probability can vary depending on what type of device on which the advertising will be made available.

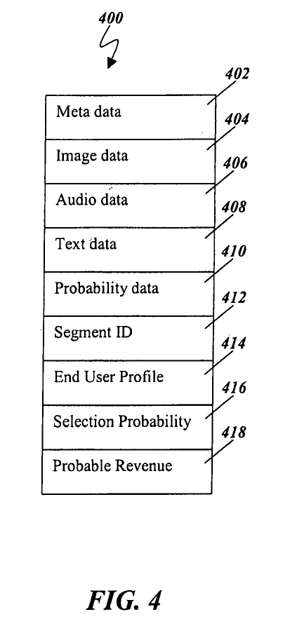

Turning now to FIG. 4, another illustrative embodiment further includes a data structure 400 associated with the video segment data. Data structure 400 includes a metadata field 402 for containing Meta data describing a particular video or video segment data. The Meta data can include but is not emailed to a description of the video data. The data structure further comprises an image data field 404 for containing image data associated with or from a particular video segment. The data structure further comprises an audio data field 406 for containing audio data associated with or from a video segment. The data structure further comprises a text data field 408 for containing text data associated with or from particular video segment. The data structure further comprises a probability data field 410 for containing data indicative of the probability of particular video segment being associated with a particular advertisement data and advertising class. The data structure further comprises auction data field 412 for containing data indicative of a particular auction value for the particular video segment. An advertising identifier (ID) field 414 is provided to contain data indicating an identifier for the video segment. The data structure further includes a field selection probability field 416 for containing selection probability data indicating an end user's probability for selecting an advertisement from a particular advertising class. The data structure further includes a probable revenue field 418 for containing data indicating probable revenue for an end user based on the product of an auction price, selection probability and probability a segment matching an advertisement from a particular advertising class.

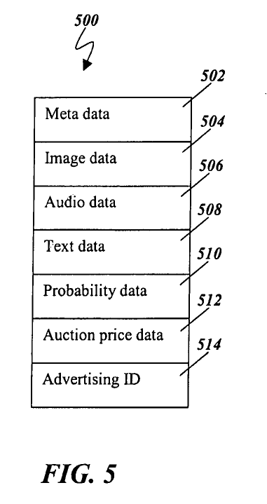

Turning now to FIG. 5, another illustrative embodiment further includes a data structure 500 associated with the advertising data. Data structure 500 includes a metadata field 502 for containing Meta data describing a particular advertising data. The Meta data can include but is not emailed to a description of the advertising data. The data structure further comprises an image data field 504 for containing image data associated with or from a particular advertisement. The data structure further comprises an audio data field 506 for containing audio data associated with or from advertising data. The data structure further comprises a text data field 508 for containing text data associated with or from particular advertisement data. The data structure further comprises a probability data field 510 for containing data indicative of the probability of particular advertisement data being associated with a particular video segment and advertising class. The data structure further comprises auction data field 512 for containing data indicative of a particular auction value for the particular advertising data. An advertising identifier (ID) field 514 is provided to contain data indicating an identifier for the advertising data.

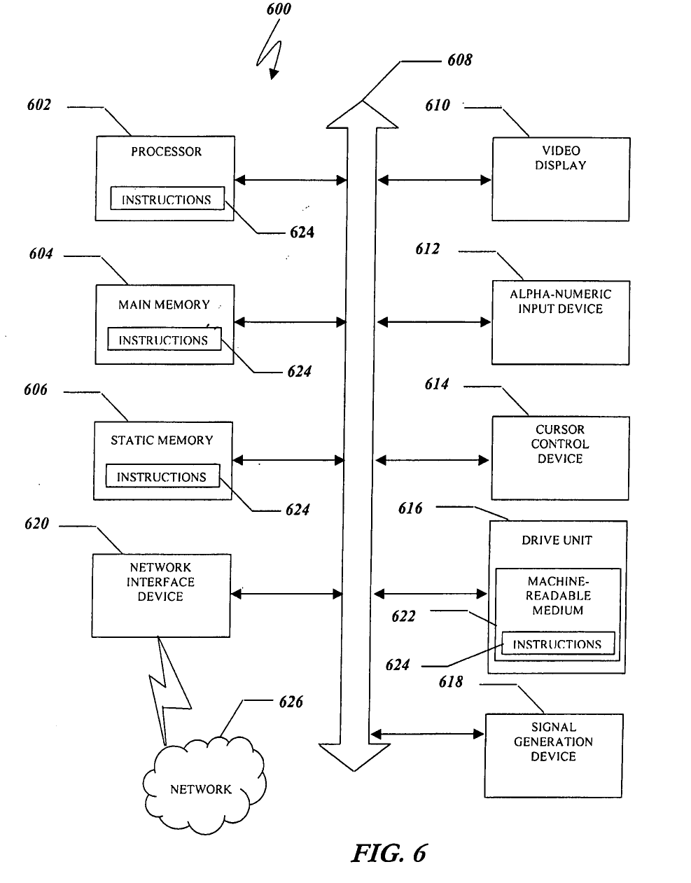

FIG. 6 is a diagrammatic representation of a machine in the form of a computer system 600 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine.

It will be understood that a device of the present invention includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 600 may include a processor 602 (e.g., a central processing unit (CPU), a graphics processing unit (GPU), or both), a main memory 604 and a static memory 606, which communicate with each other via a bus 608. The computer system 600 may further include a video display unit 610 (e.g., liquid crystals display (LCD), a flat panel, a solid state display, or a cathode ray tube (CRT)). The computer system 600 may include an input device 612 (e.g., a keyboard), a cursor control device 614 (e.g., a mouse), a disk drive unit 616, a signal generation device 618 (e.g., a speaker or remote control) and a network interface.

The disk drive unit 616 may include a machine-readable medium 622 on which is stored one or more sets of instructions (e.g., software 624) embodying any one or more of the methodologies or functions described herein, including those methods illustrated in herein above. The instructions 624 may also reside, completely or at least partially, within the main memory 604, the static memory 606, and/or within the processor 602 during execution thereof by the computer system 600. The main memory 604 and the processor 602 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but not limited to, distributed processing or component/object distributed processing, parallel processing, or virtual machine processing can also be constructed to implement the methods described herein. The present invention contemplates a machine readable medium containing instructions 624, or that which receives and executes instructions 624 from a propagated signal so that a device connected to a network environment 626 can send or receive voice, video or data, and to communicate over the network 626 using the instructions 624. The instructions 624 may further be transmitted or received over a network 626 via the network interface device 620. The machine-readable medium may also contain a data structure for containing data useful in providing a functional relationship between the data and a machine or computer in an illustrative embodiment of the disclosed system and method.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the invention is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived there from, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for selecting advertising data, comprising:
detecting a plurality of different scenes in a video data stream;
correlating each of the scenes with at least one of a plurality of advertising data classes; and
selecting advertising data for one of the scenes based on the correlation.

2. The method of claim 1, further comprising:
classifying the scenes into scene classes, wherein correlating further comprises correlating the scene classes with the advertising data classes.

3. The method of claim 1, further comprising:
auctioning an advertising spot to obtain an auction price for one of the scenes based on the correlation, plus demographics and end user devices for current end users to which the advertising will be made available.

4. The method of claim 3, wherein one of the scenes further comprises a plurality of scenes bridged together into a bridged scene, wherein the bridged scenes share a common topic based on data in the bridged scenes selected from the group consisting of image, audio and text data.

5. The method of claim 3, wherein the demographics further comprises an average demographic profile for current end user receiving the video data served by an internet protocol television (IPTV) server.

6. The method of claim 2, wherein the classifying further comprises:
seeding the scene classes with initial key words using meta data for the video data;
seeding the advertising data classes with initial key words using Meta data for the advertising data; and
determining a classification for the scene and advertising data using machine learning.

7. The method of claim 2, wherein correlating further comprises correlating feature vectors for the scenes with feature vectors for the advertising data.

8. The method of claim 2, wherein selecting further comprises:
selecting an advertising class based on a probability of a video scene class matching an advertising data class.

9. The method of claim 8, wherein selecting further comprising:
selecting highest probable revenue advertising data classification category based on an auction value for advertising data class for the advertising spot and an end user selection probability for each of the advertising data classes.

10. The method of claim 9, further comprising:
presenting as available the selected advertising data in the selected advertising class to the at least one end user;
evaluating an end user response to the advertising data; and
adjusting the end user selection probability for the advertising data classification category for the end user based on the end user response.

11. The method of claim 6, wherein the feature vectors further comprise Meta data describing the data, image data, audio data, and text data.

12. The method of claim 2, wherein the classifying further comprises:
seeding the advertising data classes with advertising data;
developing the advertising data classes; and
determining a classification for the scene into an advertising data class using machine learning.

13. A system for selecting advertising data, comprising:
a processor in data communication with a computer readable medium;
a computer program embedded in the computer readable medium, the computer program comprising instructions to detect a plurality of different scenes in a video data stream, instructions to correlate each of the scenes with a plurality of advertising data classes and instructions to select advertising data for one of the scenes based on the correlation.

14. The system of claim 13, the computer program further comprising:
instructions to classify the scenes into scene classes, wherein correlating further comprises correlating the scene classes with the advertising data classes.

15. The system of claim 13, the computer program further comprising:
instructions to auction an advertising spot to obtain an auction price for one of the scenes based on the correlation, plus demographics and end user devices for current end users to which the advertising will be made available.

16. The system of claim 15, wherein one of the scenes further comprises a plurality of scenes bridged together into a bridged scene, wherein the bridged scenes share a common topic based on data in the bridged scenes selected from the group consisting of image, audio and text data.

17. The system of claim 15, wherein the demographics further comprise an average demographic profile for current end users receiving the video data served by an internet protocol television (IPTV) server.

18. The system of claim 14, wherein the instructions to classify further comprise instructions to seed the scene classes with initial key words using Meta data for the video data, instructions to seed the advertising data classes with initial key words using meta data for the advertising data and instructions to determine a classification for the scene and advertising data using machine learning.

19. The system of claim 14, wherein correlating further comprises correlating feature vectors for the scenes with feature vectors for the advertising data.

20. The system of claim 14, wherein the instructions to select further comprise instructions to select an advertising class based on a probability of a video scene class matching an advertising data class.

21. The system of claim 20, wherein the advertising data class is developed from an initial seed of advertising data.

22. The system of claim 20, wherein the instructions to select further comprise selecting a highest probable revenue advertising data classification category based on an auction value for advertising data class for the advertising spot and an end user selection probability for each of the advertising data classes.

23. A computer readable medium containing instructions that when executed by a computer perform a method for selecting advertising data the computer program comprising instructions to detect a plurality of different scenes in a video data stream, instructions to correlate each of the scenes with a plurality of advertising data classes and instructions to select advertising data for one of the scenes based on the correlation.

24. A data structure embedded in a computer readable medium, the data structure comprising:
a first field for containing data indicative of a video segment classification; and
a second field for containing data indicative of an advertising data classification; and
a third field for containing data indicative of a probability of the video segment classification matching the advertising data classification.

25. A system for receiving advertising data, comprising:
a processor in data communication with a computer readable medium; and
a computer program embedded in the computer readable medium, the computer program comprising instructions to receive advertising data available indicators for a plurality of different scenes in a video data stream.
